(19) United States
(12) Patent Application Publication
(10) Pub. No.: US 2007/0087200 A1
(43) Pub. Date: Apr. 19, 2007

(54) Composite vehicle panel

(76) Inventors: Harald Batke, Mueden/Aller (DE); Hans-Joachim Langhoff, Gifhorn (DE); Matthias Ludwig, Vechelde (DE); Fred Melzian, Kusey (DE); Herbert Beck, Wolfenbuttel (DE); Ralf Behmer, Braunschweig (DE); Sven Hardel, Wettendorf (DE); Frank Niebuhr, Wilsche (DE); Tobias Niesner, Gifhorn (DE); Volker Staciwa, Wahrenholz (DE)

Correspondence Address: CARLSON, GASKEY & OLDS, P.C., 400 WEST MAPLE ROAD, SUITE 350, BIRMINGHAM, MI, 48009, US

(21) Appl. No.: 11/582,270

(22) Filed: Oct. 17, 2006

(30) Foreign Application Priority Data
Oct. 17, 2005 (EP) 05 022 620 8
Oct. 24, 2005 (EP) 05 023 149.7

(51) Int. Cl. B32B 9/00

(52) U.S. Cl. 428/411.1

(57) ABSTRACT

A composite part, in particular a vehicle panel such as a car body attachment part, a movable glass cover, or an interior space lining, comprises a foamed plastic layer and an elongated, extruded plastic body. The elongated, extruded plastic body enhances stability of the car body attachment part, is reinforced with fibers, and is embedded in the plastic layer at least in sections.

### RELATED APPLICATIONS

The application claims priority to European Patent Application No. 05 022 620.8 filed Oct. 17, 2005, and European Patent Application No. 05 023 149.7 filed Oct. 24, 2005.

### BACKGROUND OF THE INVENTION

The invention relates to a composite part, in particular a vehicle panel.

Vehicle panels are, for instance, large-area interior space lining parts and large-area car body attachment parts. Car body attachment parts for a vehicle, in turn, are components that are mounted to a car body, such that when mounted they define an outer skin of the vehicle, at least in sections, which is visible from outside the vehicle. Car body attachment parts may include flaps (doors, covers), bumpers or vehicle roof panels (roof modules or covers for roof opening systems), for example.

To reinforce foamed car body attachment parts, it is common to embed elongated steel insert parts in the form of hollow sections in a plastic layer. After a foaming and cooling process, attachment parts are frequently adjusted by hand because the steel, which has been heated by hot plastic material, contracts and induces a different curvature of the attachment part. Alternatively, the steel insert parts are embedded in foam in a preloaded state, requiring precise coordination so that a cooled-off attachment part has the desired shape and curvature immediately without any additional straightening operation. The production of foamed car body attachment parts such as glass covers for sliding or spoiler roofs, which have a rear side provided with a foam backing at a periphery, is particularly complicated.

The objective of the invention is to provide a large-area (i.e. a small thickness compared with a visible outer side) composite part, in particular a vehicle panel, which can be manufactured easily, has a very good quality and, among others things, is very solid.

### SUMMARY OF THE INVENTION

This objective is accomplished by providing a composite part, in particular a vehicle panel, comprising a foamed plastic layer and an elongated, extruded and prefabricated plastic body that enhances stability of the composite part. The plastic body is reinforced with fibers (carbon fibers or glass fibers, for example) and embedded in the plastic layer at least in sections. One advantage achieved by the invention is that the differing expansion and shrinking behavior of the plastic layer and the plastic body is diminished due to the plastic layer and the plastic body having coefficients of thermal expansion that are virtually identical. Thus, a car body attachment part will not arch at elevated temperatures as was the case with previous steel insert parts owing to a bimetal effect, and impairments of surface quality will be averted. The fiber-reinforced plastic body considerably enhances the stability of the car body attachment part and, compared with a steel insert part, provides for a reduction in weight of the car body attachment part.

The advantage of the invention is particularly effective with components having an outer skin made of glass that is provided with a foam backing, because by employing a plastic body with a glass fiber content of more than 30% by weight, the coefficients of thermal expansion of the outer skin and reinforcement part will be equalized.

It is preferred that the plastic body be completely embedded in the plastic layer. The plastic body therefore is surrounded by the plastic layer on all sides.

It is preferred that an elongated steel reinforcement section for enhancing the rigidity is not provided in the plastic layer in the region of the plastic body. Rigidity is provided by the fiber-reinforced plastic body in combination with the plastic layer.

The fibers preferably have a length of at least 200 mm, so that a high tensile strength will be achieved.

According to the preferred embodiment, the fibers run across an entire length of the plastic body, i.e. towards opposite end faces of the plastic body.

The fibers are configured as strands, for instance, which extend almost parallel to each other. Fibers, which are arranged in strands, enhance the stability in a tensile direction.

As an alternative, the fibers may also be braided.

The fibers, in particular, extend essentially parallel to an outer edge of the composite part, which results in an elongated, flexural-resistant reinforcement part with high tensile strength.

The composite part preferably has an outer skin that is provided with a foam backing in the form of the plastic layer. A plastic foil provided with a foam backing at a rear side, in particular a two-layered coextrusion foil which is dyed throughout, and/or a plate-shaped, separate roof part (e.g. a glass panel) may serve as the outer skin. For an interior lining part, the outer skin is usually a textile or leather piece, or a printed foil.

The plastic layer preferably is produced by a long fiber injection (LFI) method. In this method, relatively short glass fibers are injected in the plastic layer. If the plastic layer also includes glass fibers, the coefficients of thermal expansion of the plastic layer and the plastic body, as well as of the glass panel, where appropriate, will approximate each other even more so that the bimetal effect may be neglected.

The plastic body preferably has protrusions that project into the plastic layer. The protrusions may extend across an entire length of the plastic body or be provided punctually, i.e. in a point-like, non-elongated, configuration. The protrusions have undercuts for enhancing bonding between the plastic layer and the plastic body.

The protrusions may reach as far as to an adjoining part, for instance a glass panel of a cover, and in this case the protrusions would serve as spacers between the plastic body and the glass panel in order to ensure that a width of a gap between the two parts will remain constant during formation of the foam backing so that a foam can be distributed uniformly in the gap.

The protrusions, for example, extend as far as to an outer side of the plastic layer, and position the plastic body in the foaming mold during the foaming process. When the car body attachment part has been taken out of the mold, the plastic protrusions differ only slightly from the plastic layer that surrounds the protrusions (in contrast to steel insert parts), and in this way represent an irrelevant impairment of the appearance of the surface.

The outer side of the plastic body preferably has indentations with undercuts, which likewise enhance connection between the plastic layer and the plastic body.

If at least one cavity is provided in the plastic body, the cavity will provide weight reduction and will reduce the amount of foaming material.

The cavity is closed by caps, for instance, which prevent the foaming material from penetrating into the cavity when the plastic layer is foamed.

According to one embodiment, the plastic body is an elongated hollow section. A signal transmission line, for instance, may run in this hollow section. The signal transmission line connects an antenna arranged on a vehicle roof panel, with an electronic system of the vehicle, or serves to power the cover.

In particular, the car body attachment part is a cover for a roof opening system. Here, the roof opening system may be a so-called “sliding/tilting” roof in which the cover, during retraction, is moved to lie below a rigid roof skin, or a so-called “spoiler” roof in which the cover is moved to lie above the roof skin. The cover can be configured as a glass cover or solar cover, among other things.

The plastic body preferably extends along a transverse side or a longitudinal side of the cover to form a substitution for a frame.

The plastic layer preferably is provided only at an edge of the cover, i.e. a middle portion of the cover will not be provided with the plastic foam backing.

These and other features of the present invention can be best understood from the following specification and drawings, the following of which is a brief description.

### BRIEF DESCRIPTION OF THE DRAWINGS

FIG. 1 shows a schematic perspective view of a vehicle roof including a composite part according to the invention in the form of a car body attachment part, here in the form of a cover.

FIG. 2 is an enlarged sectional view through the car body attachment part according to the invention in a first embodiment along line II-II in FIG. 1.

FIG. 3 is an enlarged sectional view through the car body attachment part according to the invention in a second embodiment along line II-III in FIG. 1.

FIG. 4 shows a perspective view of an interior lining part according to the invention.

### DETAILED DESCRIPTION OF THE PREFERRED EMBODIMENT

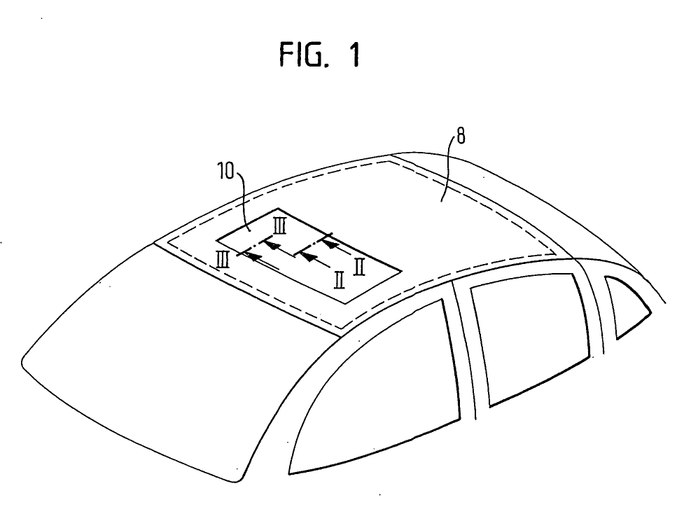

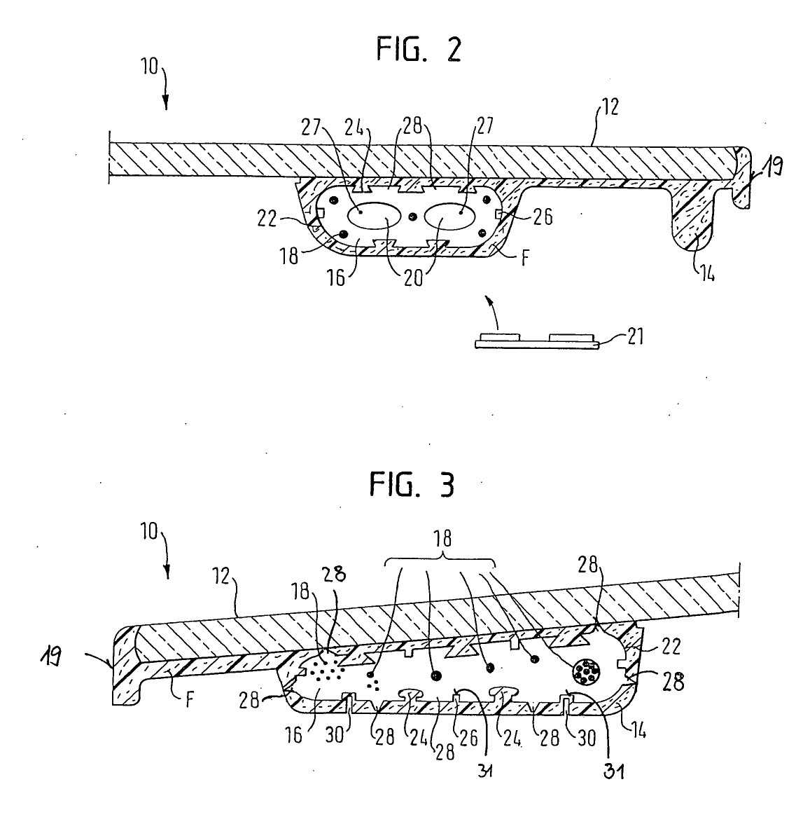

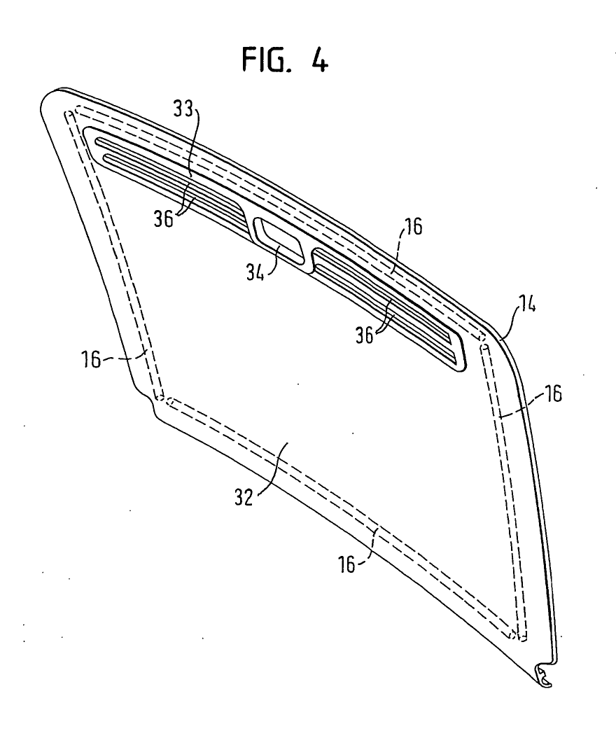

FIG. 1 shows a composite part in the form of a car body attachment part, more specifically in the form of a vehicle roof panel. The vehicle roof panel may be a roof module 8 or a cover 10 of an openable vehicle roof. FIGS. 2 and 3 explain two embodiments of the vehicle roof panel in the form of the cover 10 in more detail.

In FIGS. 2 and 3, the cover 10 can be lifted and is configured to be movable. Here, a so-called “sliding-tilt” roof could be utilized in which the cover 10, during retraction, is moved to lie below a rigid roof skin; or a so-called “spoiler roof” could be utilized in which the cover 10 is moved to lie above the rigid roof skin.

An outer skin 12 of cover 10 is defined by a glass panel or a coextrusion foil. The coextrusion foil is made of plastic or aluminum, is preferably dyed throughout and replaces an external painting. The outer skin 12 is that part of the vehicle that is visible from outside the vehicle.

Directly adjoining the outer skin 12 is a plastic layer 14, which is manufactured as a foam backing comprised of polyurethane foam (PU foam), with glass fibers F optionally being injected in the foam by the LFI method. The plastic layer 14 continuously extends, similar to a bead, along an edge 19 of the cover 10 as a one-piece frame around the cover 10, or extends only along transverse or longitudinal edges.

An elongated, extruded and prefabricated plastic body 16, generally formed so as to be oval (as seen in cross-section), is embedded in the plastic layer 14. The surrounding plastic layer 14 is configured here to have an almost constant thickness in all areas, in order to avoid dents and improve the surface quality. No ribs or such things protrude outwards.

The plastic body 16 is made of a thermoplastic resin, in particular of ABS (Acrylonitrile-butadiene-styrene-copolymer) or polypropylene, and is reinforced with glass fibers 18, for example. Carbon fibers could be used as an alternative. The glass fibers 18 run through the entire plastic body 16 in parallel relationship to the edge 19 of the cover 10 and, thus, are parallel to each other. The glass fibers 18, acting as a reinforcement, have a length of at least 200 mm and can be combined into strands with varying thicknesses, or may also be braided (see thicker bundles of glass fibers 18 in FIG. 3). The glass fiber amount lies above 30% by weight of the plastic body 16.

FIG. 2 shows two oval cavities 20 crossing the plastic body 16, which is configured as a hollow section. These cavities 20 reduce a net weight of the plastic body 16 and, thus, of the entire cover 10. The cavities 20 have their end faces closed by caps 21 that prevent foam material from entering the cavities 20 during foaming of the plastic layer 14.

The caps 21 may also engage in grooves 26 provided on an outer side 22 of the plastic body 16 (FIG. 2). In case the caps 21 have latching fingers, for instance, the caps 21 could make a clip connection with the grooves 26.

A signal transmission element 27 (electric cable, tensile mechanism and the like) can be laid in the hollow profile.

Protrusions 28, which either are provided punctually (non-elongated configuration), or which run along the entire length of the plastic body 16, project into the plastic layer 16. The protrusions 28 can be shaped like a trapezoid or a mushroom in order to create undercuts 24 which improve the bonding between the plastic layer 14 and the plastic body 16.

Furthermore, the special features of the cover 10 shown in FIG. 3 will be explained. In other respects FIG. 3 conforms to the cover 10 shown in FIG. 2, and reference is made to the above explanations. The same reference numerals are used for identical components.

Some protrusions 28 of the plastic body 16, which are shown in FIG. 3, extend as far as to the outer side of the plastic layer 14 and serve for positioning the plastic body 16 in a foaming mold.

Some protrusions 28 also adjoin to the adjacent glass panel and define spacers which during foaming and curing the plastic layer 14 keep the distance between the plastic body 16 and the glass panel constant.

Recesses 30 in the plastic layer 14, which are shown in FIG. 3, further continue as indentations 31 in the plastic body 16, for holding inserts for attachment parts. In case the car body attachment part is a roof module 8, it is possible to fix sun shades to these inserts, for instance.

At least along the side edges 19, along which the plastic bodies 16 run, an elongated steel reinforcement section is not provided. It is possible that fastening flanges for attaching the cover 10 to movable carriages could be embedded in the plastic layer 14.

During production of the car body attachment part, the outer skin 12, which is defined by a glass panel or a coextrusion foil, is laid in a foaming tool. The plastic body 16, which has been made from polypropylene or ABS (Acrylonitrile-butadiene-styrene-copolymer) in a separate working step and is reinforced with glass fibers 18, is positioned in the foaming tool by the protrusions 28. Liquid PU material is introduced in the closed mold, with glass fibers F being optionally co-injected (LFI method). The PU material foams up, fills the cavity formed in the foaming tool and adheres to the rear side of the outer skin 12.

In one embodiment, in which the entire roof module has the whole area of a rear side of the roof module provided with a foam backing in the form of the plastic layer 14, plastic bodies 16 likewise are provided only along the edges 19, in order to form a reinforcement frame. Thus, these roof modules—as seen in a section of the edge zone—have the same appearance as the cover illustrated in the Figures.

With a roof module, foam is introduced in an open foaming mold, which is equipped with the outer skin 12 and the plastic body 16. Only after this, the foaming mold is closed. Here too, no elongated steel reinforcement sections are provided at these side edges where plastic bodies 16 are provided.

FIG. 4 shows a vehicle interior lining part in the form of a shiftable roof liner 32 that can be moved to lie in front of a sliding roof cover. This roof liner comprises an outer skin 12 (FIGS. 2-3) made of a foil or a textile material, which has a whole area of a rear side of the outer skin 12 provided with a foam backing in the form of a fiber-reinforced plastic layer 14 (LFI method). The fiber-reinforced plastic bodies 16 (illustrated in broken lines), which are completely embedded in the plastic layer 14, define a stiffening frame. A ventilation molding 33 including a handle 34 and slots 36 is put into the panel. Also, in this embodiment, a thickened and bead-like portion of the plastic layer 14 extends along the edge. This thickened portion is the zone where the plastic bodies 16 are situated.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A composite part, in particular a vehicle panel, comprising:
a foamed plastic layer;
an elongated, extruded plastic body that enhances stability of the composite part wherein the elongated, extruded plastic body is reinforced with fibers and wherein at least some sections of the elongated, extended plastic body is embedded in the foamed plastic layer.

2. The composite part according to claim 1 wherein the composite part is one of a car body attachment part and an interior lining part.

3. The composite part according to claim 1 wherein the fibers are one of glass fibers and carbon fibers.

4. The composite part according to claim 1 wherein the elongated, extruded plastic body is completely embedded in the foamed plastic layer.

5. The composite part according to claim 1 wherein a plastic body is provided along unreinforced side edges of the composite part.

6. The composite part according to claim 1 wherein the fibers have a length of at least 200 mm.

7. The composite part according to claim 1 wherein the fibers are configured as strands that are substantially parallel to each other.

8. The composite part according to claim 1 wherein the fibers are essentially parallel to an outer edge of the composite part.

9. The composite part according to claim 1 wherein the composite part has an outer skin comprised of glass and wherein the foamed plastic layer comprises a foam backing.

10. The composite part according to claim 1 wherein the foamed plastic layer is produced by the LFI method.

11. The composite part according to claim 1 wherein the elongated, extruded plastic body has protrusions that project into the foamed plastic layer.

12. The composite part according to claim 11 wherein the protrusions reach as far as to at least one of an adjoining part and an outer side of the foamed plastic layer.

13. The composite part according to claim 1 wherein an outer side of the elongated, extruded plastic body has indentations.

14. The composite part according to claim 1 wherein at least one cavity is provided in the elongated, extruded plastic body.

15. The composite part according to claim 1 wherein the elongated, extruded plastic body is an elongated hollow section.

16. The composite part according to claim 1 wherein the composite part is a cover for a roof opening system.

17. The composite part according to claim 16 wherein the elongated, extruded plastic body extends along one of a transverse side and a longitudinal side of the cover.

18. The composite part according to claim 16 wherein the foamed plastic layer is only provided at an edge of the cover.
